(19) United States
(12) Patent Application Publication
(10) Pub. No.: US 2026/0158893 A1
(43) Pub. Date: Jun. 11, 2026

(54) Electric Motor Medical Chair with Handbrakes

(71) Applicant: Reginald Keith Sapp, Clinton, MD (US)

(72) Inventor: Reginald Keith Sapp, Clinton, MD (US)

(21) Appl. No.: 18/975,009

(22) Filed: Dec. 10, 2024

(51) Int. Cl. B60K 1/02; B60K 17/16; B60K 17/356

(52) U.S. Cl. CPC B60K 1/02; B60K 17/16; B60K 17/356

(57) ABSTRACT

The Electric Motor Medical Chair with Hand Brake is propelled by an electric motors configuration Fig (H), the shaft FIG. 1(M) and the differential FIG. 1(L).

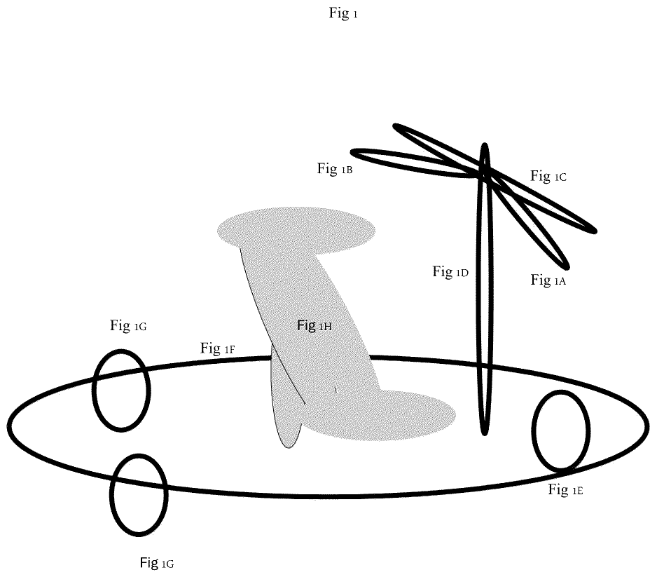

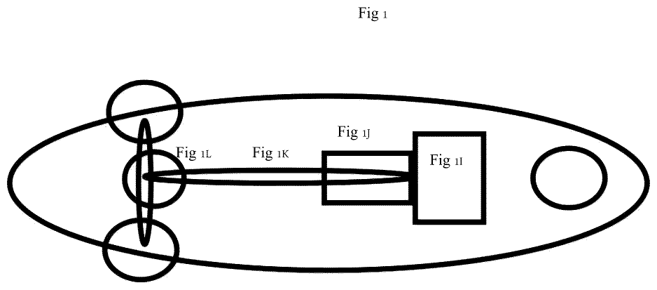

It is designed to be controlled and stop by Handbrakes FIG. 1(B). It will turn left, and right by the handlebars FIG. 1(A). The front wheel as in FIG. 1(F) gives it better control around turns. The foot rest on the body FIG. 1(E) for comfort while traveling. The rear has a battery FIG. 1(G).

This is an Electric Motor Medical Chair with Hand Brakes FIG. 1 with hand break/s FIG. 1A front brakes and FIG. 1B back brakes. It has the compacity to move 2000 lbst by electric motor FIG. 1J from an electric motor assembly FIG. 1K (The Shaft) and FIG. 1L (The rear wheel connected to the shaft and motor).

The wheels FIG. 1E (front) and FIG. 1G (Rear) glides it on grounds of grass, dirt or concert. The Platform to the handlebars to Throttle FIG. 1C is configured with hand breaks FIG. 1A (Front Brakes) and FIG. 1B (Rear Brakes).

The driving apparatus for proportion is the Electric motor FIG. 1J and Shaft FIG. 1K to the rear wheel FIG. 1G. This two-wheel toy is powered by a conventional battery FIG. 1I for its power source.

1. It was found that a car or a truck starter motor will compel a heavy object forward. The car weight between 5 lb to 2000 lb+. The test was done with a car starter.
It could not be balance with motor on one side due to car differential that spends both wheels. We concluded that dual motors was needed to balance the motion and weight forward. This is know as 4×4 All Wheel Drive.
The motor is a high amp and high voltage motor which handle the stress of weight without burnout from 5 lb to 2000+lbs.
